(19) United States
(12) Patent Application Publication
(10) Pub. No.: US 2014/0063775 A1
(43) Pub. Date: Mar. 6, 2014

(54) LIGHTING APPARATUS USED IN PHOTOGRAPHY AND MOBILE ELECTRONIC DEVICE PROVIDED WITH SAME

(71) Applicant: PANASONIC CORPORATION, Osaka (JP)

(72) Inventors: Nami Sawada, Hyogo (JP); Kazuhiro Daijo, Osaka (JP)

(73) Assignee: PANASONIC CORPORATION, Osaka (JP)

(21) Appl. No.: 14/117,979

(22) PCT Filed: Jun. 28, 2012
(86) PCT No.: PCT/JP2012/004194

§ 371 Date: Nov. 15, 2013

(30) Foreign Application Priority Data
Jul. 6, 2011 (JP) 2011-149825

(51) Int. Cl. G03B 15/06

(52) U.S. Cl. CPC G03B 15/06
USPC 362/16

(57) ABSTRACT

The present invention includes a light-emitting element, and a reflector including a reflection face that reflects light from the light-emitting element toward a rectangular area to be photographed. The reflection face includes a pair of first refection faces facing each other with the light-emitting element interposed therebetween in a direction corresponding to a long-side direction demarcating the area to be photographed, and a pair of second reflection faces facing each other with the light-emitting element interposed therebetween in a direction corresponding to a short-side direction demarcating the area to be photographed. Furthermore, a height of the second reflection faces is lower than a height of the first reflection faces. This makes it possible to achieve a lighting apparatus used in photography, which is small and with which the whole area to be photographed is illuminated uniformly.

This application is a U.S. National Phase Application of PCT International Application PCT/JP2012/004194.

### TECHNICAL FIELD

The present invention relates to a lighting apparatus used in photography, which is used for illuminating an area to be photographed when photographing is carried out, and to a portable electronic device provided with the same.

### BACKGROUND ART

Conventionally, in portable electronic devices such as a digital camera and a portable telephone equipped with a camera, a lighting apparatus used in photography is mounted (see, for example, Patent Literature 1).

Hereinafter, a lighting apparatus used in photography disclosed in Patent Literature 1 is described with reference to FIGS. 3 to 4B. FIG. 3 is a perspective view of a conventional lighting apparatus used in photography. FIG. 4A is a sectional view taken on line 4A-4A in FIG. 3, and FIG. 4B is a sectional view taken on line 4B-4B in FIG. 3.

As shown in FIG. 3, conventional lighting apparatus 100 used in photography includes light-emitting element 103 provided on substrate 102, and reflector 104 that reflects light from light-emitting element 103 toward a rectangular area to be photographed. Reflector 104 includes peripheral wall 105 disposed on substrate 102 in such a manner to surround light-emitting element 103, and reflection face 106 extending to the outside from the periphery of light-emitting element 103. Peripheral wall 105 includes a pair of first peripheral wall formation parts 107 facing each other with light-emitting element 103 interposed therebetween in a direction corresponding to a long-side direction demarcating the area to be photographed, and a pair of second peripheral wall formation parts 108 facing each other with light-emitting element 103 interposed therebetween in a direction corresponding to a short-side direction demarcating the area to be photographed.

First peripheral wall formation parts 107 and second peripheral wall formation parts 108 constituting peripheral wall 105 are formed unitarily so as to configure a square-shaped outer contour in a plan view.

Furthermore, reflection face 106 includes a pair of first reflection faces 109 and a pair of second reflection faces 110, and is formed in a square shape in a plan view. The pair of first reflection faces 109 are provided in such a manner to extend from vicinities 103a of both sides of light-emitting element 103 in the direction corresponding to the long-side direction demarcating the area to be photographed toward end portions 107a of first peripheral wall formation parts 107. On the other hand, the pair of second reflection faces 110 are provided in such a manner to extend from vicinities 103b of both sides of light-emitting element 103 in the direction corresponding to the short-side direction demarcating the area to be photographed toward end portions 108a of second peripheral wall formation parts 108.

At this time, as shown in FIGS. 4A and 4B, peripheral wall 105 and reflection face 106 are provided in such a manner that height H1 of first peripheral wall formation parts 107 of peripheral wall 105 and first reflection faces 109 of reflection face 106 is the same as height H2 of second peripheral wall formation parts 108 of peripheral wall 105 and second reflection faces 110 of reflection face 106 with respect to a surface provided with light-emitting element 103 of substrate 102 as a reference plane. That is to say, peripheral wall 105 is formed such that end portions 107a of first peripheral wall formation parts 107 and end portions 108a of second peripheral wall formation parts 108 are flush.

Furthermore, light-emitting element 103 is disposed in a center part of substrate 102 in a region surrounded by peripheral wall 105 including first peripheral wall formation parts 107 and second peripheral wall formation parts 108. Reflection face 106 including the pair of first reflection faces 109 and the pair of second reflection faces 110 is formed in such a manner to extend from vicinities 103a and 103b of light-emitting element 103 toward end portions 107a and 108a of peripheral wall 105 including first peripheral wall formation parts 107 and second peripheral wall formation parts 108. At this time, first reflection faces 109 and second reflection faces 110 of reflection face 106 are formed in a curve in a concave shape in a direction away from light-emitting element 103 (direction toward end portions 107a and 108b of peripheral wall 105).

However, in conventional lighting apparatus 100 used in photography, reflection face 106 extends toward flush end portions 107a and 108a of peripheral wall 105 from vicinities 103a and 103b of light-emitting element 103. Therefore, lighting apparatus 100 used in photography illuminates a square-shaped area corresponding to the shape of reflection face 106 of reflector 104.

As a result, since the area to be photographed in a general portable electronic device is set to a rectangular area, the above-mentioned lighting apparatus 100 used in photography cannot uniformly illuminate a whole part of the rectangular area to be photographed.

That is to say, while a shape of the area to be photographed of a portable electronic device on which lighting apparatus 100 used in photography is mounted is a rectangle having a short side and a long side, a shape of an irradiation area of the above-mentioned lighting apparatus 100 used in photography is a square whose all sides are equal to each other. The shape of the area to be photographed does not coincide with the shape of the irradiation area. Therefore, in order to illuminate the inside of the area to be photographed by using the above-mentioned lighting apparatus 100 used in photography, it is necessary to illuminate the outside of the irradiation area. As a result, there is a problem that light efficiency of lighting the rectangular area to be photographed (a ratio of a light amount capable of lighting the area to be photographed to a total light-emitting amount) is deteriorated.

In order to avoid the above-mentioned problem, it is thought that the irradiation area of light is expanded to a rectangular shape (for example, a shape of the irradiation area is expanded toward a direction corresponding to a direction in which the short sides demarcating the area to be photographed are arranged) by using an optical lens (not shown). However, when the irradiation area is expanded from a square shape to a rectangular shape by using the optical lens, the light diffuses, so that the density of light with which the area to be photographed is irradiated becomes nonuniform. Therefore, it becomes difficult to irradiate the area to be photographed with light by using the optical lens.

Furthermore, it is also thought that a plurality of light-emitting elements 3 is disposed in parallel in a direction corresponding to the short-side direction (a direction in which the long side extends) demarcating the area to be photographed, so that the whole part of the area to be photographed is uniformly illuminated. In this case, there is a problem that the size of lighting apparatus 100 used in photography becomes large, thus increasing the size of a portable electronic device.

### CITATION LIST

### Patent Literature

PTL 1: Japanese Patent Unexamined Publication No. 2008-172125

### SUMMARY OF THE INVENTION

In order to solve the above-mentioned problems, a lighting apparatus used in photography of the present invention includes a light-emitting element and a reflector having a reflection face that reflects light from the light-emitting element toward a rectangular area to be photographed. Furthermore, the reflection face includes a pair of first reflection faces facing each other with the light-emitting element interposed therebetween in a direction corresponding to a long-side direction demarcating the rectangular area to be photographed, and a pair of second reflection faces facing each other with the light-emitting element interposed therebetween in a direction corresponding to a short-side direction demarcating the rectangular area to be photographed. A height of the second reflection faces is lower than a height of the first reflection faces.

According to this configuration, since end portions of the second reflection faces are located closer to a substrate side as compared with end portions of the first reflection faces, the first reflection faces can control a irradiation direction (irradiation range) of light better than the second reflection faces. Thus, the first reflection faces gather light so as to reduce spread of light, and, at the same time, the second reflection faces spread light so as to irradiate the rectangular area to be photographed with the light.

That is to say, as compared with the irradiation range of light in the direction corresponding to the long-side direction demarcating the area to be photographed, the irradiation range of light in the direction corresponding to the short-side direction demarcating the rectangular area to be photographed can be made to be wider. Thus, it is possible to illuminate an area having a shape similar to the rectangular area to be photographed set in a portable electronic device. As a result, a small lighting apparatus used in photography, which can illuminate the rectangular area to be photographed set in the portable electronic device, is achieved.

### BRIEF DESCRIPTION OF DRAWINGS

FIG. 1 is a perspective view of a lighting apparatus used in photography in accordance with an exemplary embodiment of the present invention.

FIG. 2A is a sectional view taken on line 2A-2A of FIG. 1.

FIG. 2B is a sectional view taken on line 2B-2B of FIG. 1.

FIG. 3 is a perspective view of a conventional lighting apparatus used in photography.

FIG. 4A is a sectional view taken on line 4A-4A of FIG. 3.

FIG. 4B is a sectional view taken on line 4B-4B of FIG. 3.

### DESCRIPTION OF EMBODIMENTS

Hereinafter, a lighting apparatus used in photography in accordance with an exemplary embodiment of the present invention is described with reference to drawings. Note here that this exemplary embodiment does not limit the present invention. Furthermore, the lighting apparatus used in photography of this exemplary embodiment is a lighting apparatus used in photography, which is mounted on portable electronic devices such as a digital camera and a portable telephone equipped with camera and which illuminates a rectangular area to be photographed at the time of photography.

### Exemplary Embodiment

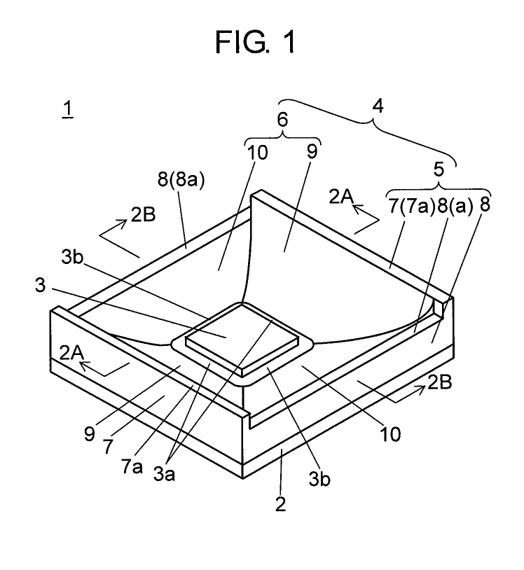

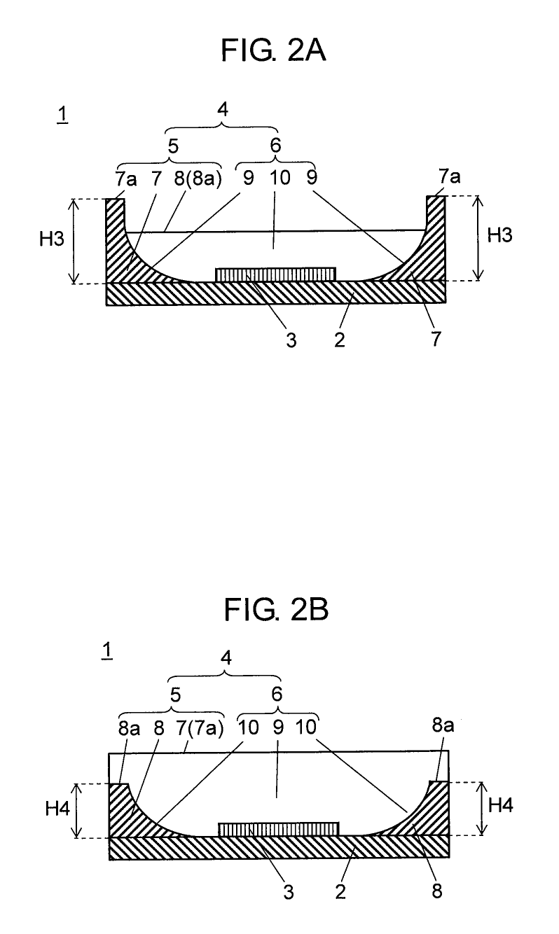

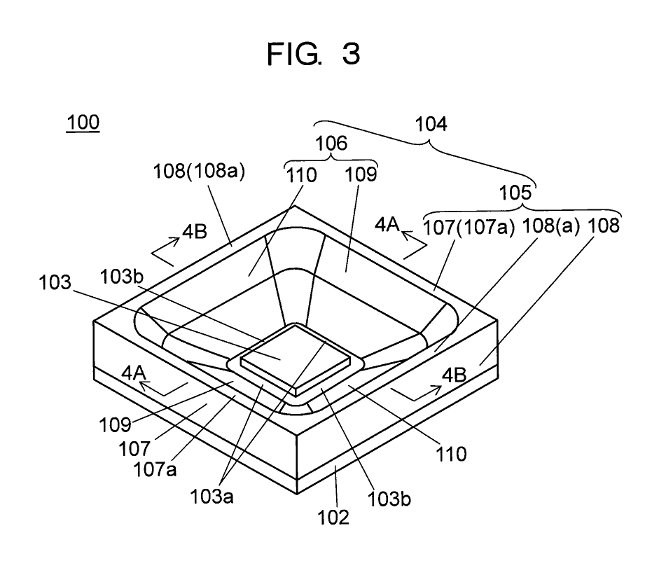

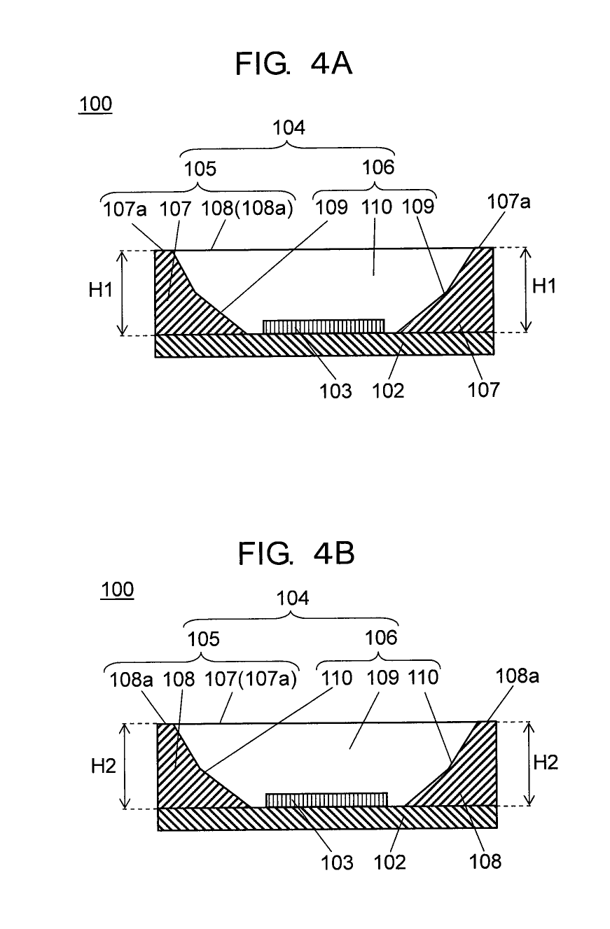

Hereinafter, a lighting apparatus used in photography in accordance with an exemplary embodiment of the present invention is described with reference to FIGS. 1 to 2B.

FIG. 1 is a perspective view of a lighting apparatus used in photography in accordance with an exemplary embodiment of the present invention. FIG. 2A is a sectional view taken on line 2A-2A of FIG. 1. FIG. 2B is a sectional view taken on line 2B-2B of FIG. 1.

As shown in FIG. 1, lighting apparatus 1 used in photography of this exemplary embodiment includes light-emitting element 3, for example, LED (Light Emitting Diode), provided on substrate 2, and reflector 4 that reflects light from light-emitting element 3 toward a rectangular area to be photographed.

Light-emitting element 3 emits light by electric power supplied via substrate 2 from a power source of a battery such as a secondary battery mounted on a portable electronic device, and radiates the light to the outside.

Reflector 4 includes peripheral wall 5 disposed on substrate 2 such that it surrounds a periphery of light-emitting element 3 packaged in a vicinity of a center part of substrate 2, and reflection face 6 which is formed unitarily with peripheral wall 5 and which extends to the outside from the periphery of light-emitting element 3. Peripheral wall 5 includes a pair of first peripheral wall formation parts 7 facing (opposed to) each other with light-emitting element 3 interposed therebetween in a direction corresponding to a long-side direction demarcating the area to be photographed, and a pair of second peripheral wall formation parts 8 facing (opposed to) each other with light-emitting element 3 interposed therebetween in a direction corresponding to a short-side direction demarcating the area to be photographed. First peripheral wall formation parts 7 and second peripheral wall formation parts 8 constituting peripheral wall 5 are formed, for example, unitarily with each other such that they configure a square outer contour. It is needless to say that first peripheral wall formation parts 7 and second peripheral wall formation parts 8 may be formed separately and then integrated with each other.

Furthermore, as shown in FIGS. 2A and 2B, reflection face 6 includes the pair of first reflection faces 9 and the pair of second reflection faces 10, and is formed in, for example, a square shape in a plan view. At this time, the pair of first reflection faces 9 are provided such that they extend in, for example, a fan shape from vicinities 3a of both sides of light-emitting element 3 toward end portions 7a of first peripheral wall formation parts 7 in a direction corresponding to the long-side direction demarcating the area to be photographed. On the other hand, the pair of second reflection faces 10 are provided such that they extend in, for example, a fan shape from vicinities 3b of both sides of light-emitting element 3 toward end portions 8a of second peripheral wall formation parts 8 in a direction corresponding to the short-side direction demarcating the area to be photographed.

First reflection faces 9 and second reflection faces 10 of reflection face 6 are formed in a concave shape, for example, in a curved shape with the same predetermined radius of curvature in a direction away from light-emitting element 3 (in a direction toward end portions 7a and 8a of peripheral wall 5). At this time, as mentioned below with reference to FIGS. 2A and 2B, a portion curved with the radius of curvature in first reflection faces 9 is formed at least to height H4 that is the same height as the height of second reflection faces 10. The portion in higher part (H3-H4) is formed linearly toward the photographing direction. When the radius of curvature is large, the portion may be formed in a curved shape with the same radius of curvature to height H3 of first reflection faces 9.

In this exemplary embodiment, first reflection faces 9 and second reflection faces 10 constituting reflection face 6 are formed in a curve such that they are linked continuously.

Furthermore, as shown in FIG. 2A, first peripheral wall formation parts 7 and first reflection faces 9 constituting peripheral wall 5 are provided such that they rise on substrate 2. At this time, one height H3 of first peripheral wall formation part 7 and first reflection face 9 to end portion 7a and the other height H3 of first peripheral wall formation part 7 and first reflection face 9 to end portion 7a, which correspond to the height in the photographing direction, are equal to each other in the height from a reference plane of substrate 2 side provided with light-emitting element 3.

Furthermore, as shown in FIG. 2B, second peripheral wall formation parts 8 and second reflection faces 10 constituting peripheral wall 5 are provided such that they rise on substrate 2. At this time, one height H4 of second peripheral wall formation part 8 and second reflection face 10 to end portion 8a and the other height H4 of second peripheral wall formation part 8 and second reflection face 10 to end portion 8a, which correspond to the height in the photographing direction, are equal to each other in the height from the reference plane of substrate 2 side provided with light-emitting element 3.

In this exemplary embodiment, height H4 of second peripheral wall formation parts 8 and second reflection faces 10 are configured to be lower than height H3 of first peripheral wall formation parts 7 and first reflection faces 9.

As mentioned above, lighting apparatus 1 used in photography of this exemplary embodiment is configured.

According to this exemplary embodiment, end portions 8a of second reflection faces 10 and second peripheral wall formation parts 8 are provided to be located closer to a substrate side as compared with end portions 7a of first reflection faces 9 and first peripheral wall formation parts 7. Therefore, as compared with second reflection faces 10, first reflection faces 9 can gather light radiated from light-emitting element 3 and control to reduce (narrow) spread of light. Thus, the light reflected from second reflection faces 10 and radiated in the direction of the area to be photographed is radiated wider as compared with the light reflected from first reflection faces 9 and radiated in the direction of the area to be photographed.

That is to say, the lighting apparatus used in photography of this exemplary embodiment can increase the irradiation range of light in the direction corresponding to the short-side direction demarcating the area to be photographed as compared with the irradiation range of light in the direction corresponding to the long-side direction demarcating the area to be photographed. As a result, an area having a shape similar to that of an area to be photographed set in the portable electronic device or the like can be illuminated substantially uniformly (including uniformly).

In the following, an operation of irradiating an area to be photographed with the light radiated by the light-emitting element in lighting apparatus 1 used in photography of this exemplary embodiment is described with reference to FIG. 1.

Firstly, electric power is supplied from a power source mounted on a portable electronic device to light-emitting element 3 via substrate 2. Thus, light-emitting element 3 emits light and releases light spread out to the outside around an optical axis of light-emitting element 3 as a center. At this time, among the light released from light-emitting element 3, the light spread out toward the pair of first reflection faces 9 and the pair of second reflection faces 10 is reflected by first reflection faces 9 and second reflection faces 10 toward the area to be photographed or other reflection faces. On the other hand, light other than the light spread out toward the pair of first reflection faces 9 and the pair of second reflection faces 10 reaches the area to be photographed without changing the travelling direction, so that the area to be photographed is irradiated.

As mentioned above, in lighting apparatus 1 used in photography of this exemplary embodiment, flush end portions 8a of the pair of second peripheral wall formation parts 8 and second reflection faces 10 are located closer to substrate 2 side as compared with flush end portions 7a of the pair of first peripheral wall formation parts 7 and first reflection faces 9. Therefore, first reflection faces 9 controls the irradiation range of light to be narrower than that of second reflection faces 10. That is to say, an irradiation angle of the light radiated in a direction in which the pair of second peripheral wall formation parts 8 (second reflection faces 10) are facing (a direction corresponding to the short-side direction demarcating the area to be photographed) is larger as compared with an irradiation angle of the light radiated in a direction in which the pair of first peripheral wall formation parts 7 (first reflection faces 9) are facing (a direction corresponding to the direction in which the long sides demarcating the area to be photographed are arranged).

Thus, the irradiation range of the light radiated toward the direction corresponding to the short-side direction demarcating the area to be photographed can be made to be wider as compared with the irradiation range of the light radiated toward the direction corresponding to the long-side direction demarcating the area to be photographed. As a result, it is possible to achieve lighting apparatus 1 used in photography which illuminates a whole area having a shape similar to the rectangular area to be photographed set in a portable electronic device substantially uniformly (including uniformly) by using a square-shaped reflector in this exemplary embodiment. Furthermore, since a whole part of the rectangular area to be photographed can be illuminated substantially uniformly by using a square-shaped reflector that is the same as a conventional reflector, the size of lighting apparatus 1 used in photography can be prevented from being increased.

Note here that the present invention is not limited to the above-mentioned exemplary embodiment. It is needless to say that the configuration can be appropriately modified within the gist of the present invention.

In other words, this exemplary embodiment describes an example in which the first reflection faces and the second reflection faces are formed in a curved shape having the same concave radius of curvature toward a direction apart from the light-emitting element, but the configuration is not limited to this. For example, the first reflection faces and the second reflection faces may be formed in a curved shape having at least two different concave radii of curvature toward a direction apart from the light-emitting element. Thus, a range of the area to be photographed, an irradiation light amount, or the like, can be adjusted easily.

Furthermore, this exemplary embodiment describes a lighting apparatus used in photography, which is not provided with an optical lens, as an example, but the configuration is not limited to this. Optical lens for controlling light from the light-emitting element may be disposed on the end portion of the peripheral wall if necessary.

Furthermore, this exemplary embodiment describes an example in which the first reflection faces and the second reflection faces are formed in the curved shape having a concave radius of curvature, but the configuration is not limited to this. For example, the first reflection faces and the second reflection faces may be formed in a taper shape having the same or different inclination angles. Thus, it is possible to achieve a lighting apparatus used in photography, which is excellent in productivity and has high processing accuracy.

Furthermore, this exemplary embodiment describes an example of a reflector in which reflection faces are unitarily formed on the inner surface of the peripheral wall. But the configuration is not limited to this. For example, as long as a reflector can be formed so as to extend to the outside from the vicinity of the periphery of the light-emitting element, the reflector may be formed in which the peripheral wall is formed of a peripheral wall member and the reflection face is formed of a reflection face member separately. Thus, it is possible to achieve a lighting apparatus used in photography, which is excellent in productivity and has high processing accuracy.

Furthermore, this exemplary embodiment describes an example in which a lighting apparatus used in photography is formed in a square shape, and irradiates a rectangular area to be photographed, but the configuration is not limited to this. For example, the reflector or the like of the lighting apparatus used in photography may be formed in a rectangular shape. Thus, the rectangular area to be photographed can be illuminated more uniformly. Also in this case, as compared with a conventional example, the length in the direction corresponding to the long-side direction demarcating the area to be photographed can be shortened. Therefore, it is possible to prevent the size of the lighting apparatus used in photography from being increased. In other words, by changing the height of the reflector, it is possible to achieve the same light distribution (light efficiency) regardless of a dimension of a long-side side.

Furthermore, this exemplary embodiment describes an example in which the height of facing peripheral walls (for example, facing first peripheral wall formation parts) and the height of the reflection faces are the same each other, but the configuration is not limited to this. The heights are not made to be the same as each other as long as control of the light by the reflection faces is not prevented. In this case, the same effect can be obtained.

### INDUSTRIAL APPLICABILITY

The present invention is useful for applications in lighting apparatus used in photography of portable electronic devices such as a digital camera and a portable telephone equipped with a camera, which require that a rectangular area to be photographed is irradiated uniformly.

### REFERENCE MARKS IN THE DRAWINGS

1, 100 lighting apparatus used in photography
2, 102 substrate
3, 103 light-emitting element
3a, 3b, 103a, 103b vicinity
4, 104 reflector
5, 105 peripheral wall
6, 106 reflection face
7, 107 first peripheral wall formation part
7a, 8a, 107a, 108a end portion
8, 108 second peripheral wall formation part
9, 109 first reflection face
10, 110 second reflection face

1. A lighting apparatus used in photography, comprising:
a light-emitting element; and
a reflector including a reflection face that reflects light from the light-emitting element toward a rectangular area to be photographed,
wherein the reflection face includes a pair of first refection faces facing each other with the light-emitting element interposed therebetween in a direction corresponding to a long-side direction demarcating the rectangular area to be photographed, and a pair of second reflection faces facing each other with the light-emitting element interposed therebetween in a direction corresponding to a short-side direction demarcating the rectangular area to be photographed, and
a height of the second reflection faces is lower than a height of the first reflection faces.

2. The lighting apparatus used in photography of claim 1, wherein the first reflection faces and the second reflection faces have a concave radius of curvature to at least the height of the second reflection faces.

3. The lighting apparatus used in photography of claim 2, wherein the first reflection faces and the second reflection faces have the same radius of curvature.

4. The lighting apparatus used in photography of claim 1, wherein the reflector is square-shaped in a plan view.

5. The lighting apparatus used in photography of claim 1, wherein the reflector includes a peripheral wall member and a reflection face member.

6. A portable electronic device equipped with a lighting apparatus used in photography as defined in claim 1.
